(19) United States
(12) Patent Application Publication
(10) Pub. No.: US 2024/0170816 A1
(43) Pub. Date: May 23, 2024

(54) METHOD FOR PRODUCING POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Tsuyoshi EHARA, Toyota-shi (JP); Yozo UCHIDA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Yasuaki NAGANO, Kosai-shi (JP); Shigeru MATSUMOTO, Toyohashi-shi (JP)

(21) Appl. No.: 18/489,002

(22) Filed: Oct. 18, 2023

(30) Foreign Application Priority Data
Nov. 21, 2022 (JP) 2022-185485

(51) Int. Cl. H01M 50/567; H01M 10/04

(52) U.S. Cl. CPC H01M 50/567; H01M 10/0481

(57) ABSTRACT

A method for producing a power storage device includes a process of insert-molding. This process is to relatively move a first mold and a second mold to press a terminal top surface of a terminal member by a top-face close-contact portion of the first mold to a second-mold side and to press a to-be-contacted portion of the terminal member by a contact portion of the second mold to a first-mold side so that a deformed portion of the terminal member is elastically deformed. A resin member is thus insert-molded while the terminal top surface is pressed and tightly contacted with the top-face contact portion.

### CROSS-REFERENCE TO RELATED APPLICATIONS

This application is based upon and claims the benefit of priority from the prior Japanese Patent Application No. 2022-185485 filed on Nov. 21, 2022, the entire contents of which are incorporated herein by reference.

### BACKGROUND

### Technical Field

The present disclosure relates to a method for producing a power storage device such as a battery or a capacitor in which a terminal member is fixed via a resin member to a case member that constitutes a part of a case.

### Related Art

As power storage devices, there is known a rectangular battery in which positive and negative terminal members are each fixed to a case having a rectangular parallelepiped box-like shape via an insert-molded resin member. To be specific, the case is composed of a bottomed rectangular tube-shaped case body having a rectangular annular opening portion and a rectangular plate-shaped lid which is joined to the case body over the entire circumference thereof to close the opening portion. Further, the positive and negative terminal members are inserted individually in a pair of insertion holes provided in the lid, and extend from the inside to the outside of the case. Further, a pair of resin members are joined to the lid and terminal members to fix the terminal members to the lid while insulating between the lid and the terminal members.

Such a battery is assembled by the following method. Namely, the positive and negative terminal members are inserted individually into the insertion holes of the lid. In this state, the resin members are made by insert-molding to integrate the terminal members with the lid via the resin members, forming a lid assembly. Subsequently, the positive and negative terminal members of this lid assembly are connected to positive and negative current collecting portions of an electrode body, respectively. Thereafter, the electrode body is inserted into the case body, and the opening portion of the case body is closed with the lid, and laser welding is performed on the entire circumference thereof to form the case. Examples of a related conventional art are disclosed in Japanese Unexamined Patent Application Publications Nos. 2010-272324 (JP2010-272324A) and 2018-097978 (JP2018-097978A) (see FIGS. 1 and 2 of JP2010-272324A and FIGS. 1 to 3 of JP2018-097978A).

### SUMMARY

### Technical Problems

Further, as the above-mentioned battery, there is a battery including positive and negative terminal members having flat terminal top surfaces. Specifically, in this battery, each terminal member includes a terminal outer portion which is located on an outer side of a lid (i.e., a case member) and which includes a flat terminal top surface, and each resin member includes a resin outer frame portion which is located on an outer side of the lid (i.e., the case member), which has a frame shape surrounding the terminal outer portion of the terminal member, and which is flush with the terminal top surface of the terminal outer portion.

As for the battery configured as above, during the above-mentioned insert-molding, a part of molten resin which is supplied around each terminal outer portion in order to form each resin outer frame portion, flows between the terminal top surface of the terminal outer portion and a molding mold. This may result in the formation of resin burrs on the terminal top surface after insert-molding. Respective terminal members have variation in their dimensions, and thus a size of clearance generated between the terminal top surface and the molding mold also has variation, resulting in variation in a state of generating the resin burrs.

The present disclosure has been made in view of such circumstances and provides a method for producing a power storage device that can prevent generation of resin burrs on a terminal top surface of a terminal member irrespective of variation in dimensions in the respective terminal members.

### Means of Solving the Problems

(1) One aspect of the present disclosure to solve the above problem is to provide a method for producing a power storage device the power storage device including: a case member including an insertion hole; a terminal member inserted in the insertion hole of the case member; and a resin member configured to be joined to the case member and the terminal member, while insulating between the case member and the terminal member, to fix the terminal member to the case member, the terminal member including: a terminal outer portion located on an outer side of the case member and provided with a terminal top surface having an exposed flat shape; and a terminal inner portion located on an inner side of the case member and connected to the terminal outer portion through the insertion hole, the resin member including a resin outer frame portion located on the outer side of the case member in a frame shape to surround a periphery of the terminal outer portion of the terminal member, the resin outer frame portion being flush with the terminal top surface of the terminal outer portion, wherein the method comprises insert-molding the resin member while the terminal member is inserted in the insertion hole of the case member, insert-molding includes: relatively moving a first mold having a flat top-face contact portion configured to face and tightly contact with the terminal top surface of the terminal outer portion and a second mold having a contact portion to contact with a to-be-contacted portion of the terminal inner portion in an orthogonal direction orthogonal to the top-face contact portion; pressing the terminal top surface by the top-face contact portion of the first mold to a second-mold side in the orthogonal direction and pressing the to-be-contacted portion by the contact portion of the second mold to a first-mold side in the orthogonal direction; and insert-molding the resin member in a state in which a deformed portion of the terminal member positioned between the terminal top surface and the to-be-contacted portion is compressed and elastically deformed in the orthogonal direction to press and tightly contact with the terminal top surface on the top-face contact portion.

In the above-mentioned method for producing the power storage device, in the process of insert molding, the first mold and the second mold are relatively moved in the orthogonal direction to compress and elastically deform the deformed portion of the terminal member in the orthogonal direction. Accordingly, the terminal top surface of the terminal member can be pressed and tightly contacted with the top-face contact portion of the first mold by the force of the mostly same magnitude with no influence of variation in dimensions of the respective terminal members in the orthogonal direction. Further, in this state, the resin member is insert molded. Thus, in molding the resin member, the terminal top surface of the terminal member is in close contact with the top-face contact portion of the first mold by the reaction force generated in the deformed portion of the terminal member, so that the molten resin is less likely to flow in between the terminal top surface and the top-face contact portion. Therefore, generation of resin burrs on the terminal top surface can be prevented irrespective of dimension variation in the respective terminal members.

(2) Further, in the method for producing the power storage device according to the above (1), preferably, the deformed portion of the terminal member is the to-be-contacted portion.

In the above-mentioned method for producing the power storage device, in the terminal member, the to-be-contacted portion to contact with the contact portion of the second mold constitutes the deformed portion which will be elastically deformed. The to-be-contacted portion of the terminal member is exposed from the resin member, and by constituting the to-be-contacted portion as the deformed portion, an elastically deformed state of the to-be-contacted portion (the deformed portion) can be easily confirmed by visual check after insert-molding.

### BRIEF DESCRIPTION OF THE DRAWINGS

FIG. 1 is a perspective view of a battery in an embodiment;

FIG. 2 is a cross-sectional view of the battery in the embodiment, taken along a battery height direction and a battery width direction;

FIG. 3 is a partially enlarged top view of a terminal member and a resin member of the battery, and their surroundings in the embodiment;

FIG. 4 is a cross-sectional view of the terminal member and the resin member of the battery, and their surroundings in the embodiment, as seen in a direction indicated by arrows A-A in FIGS. 3 and 5;

FIG. 5 is a cross-sectional view of the terminal member and the resin member of the battery, and their surroundings in the embodiment, as seen in a direction indicated by arrows B-B in FIGS. 3 and 4;

FIG. 6 is a flowchart showing a method for the battery in the embodiment;

FIG. 7 illustrates a state where molten resin is injected from a gate into a cavity in an insert-molding step in the method for producing the battery in the embodiment; and

FIG. 8 illustrates a state where a resin member is molded in the cavity in the insert-molding step in the method for producing the battery in the embodiment.

### DETAILED DESCRIPTION OF THE EXEMPLARY EMBODIMENTS

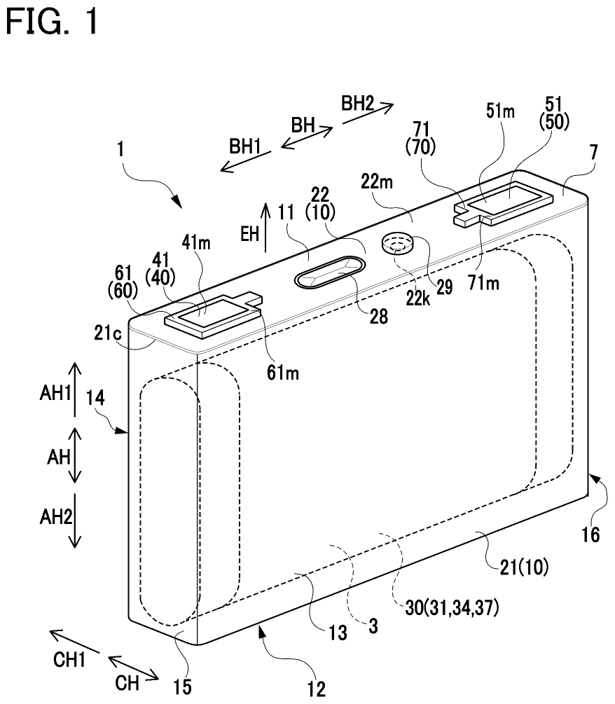

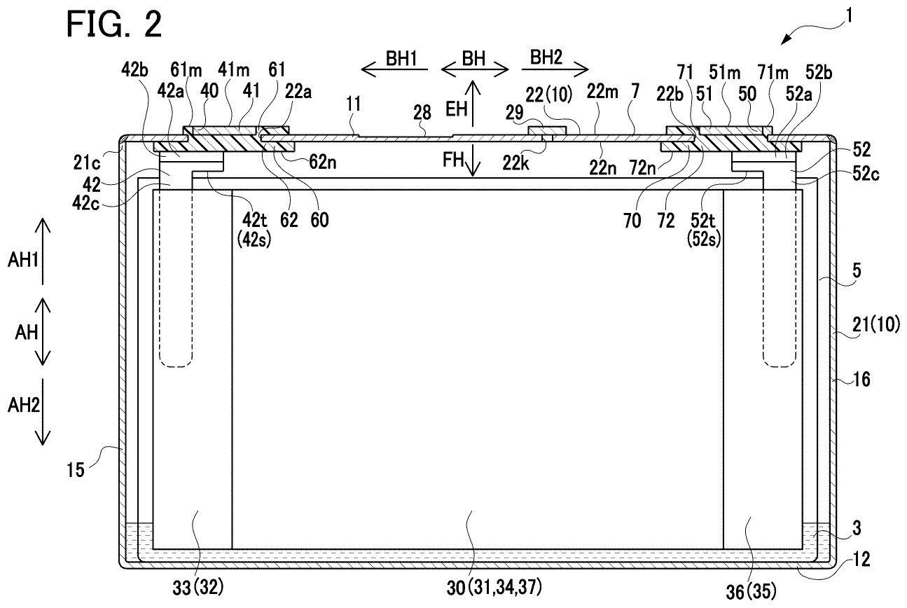

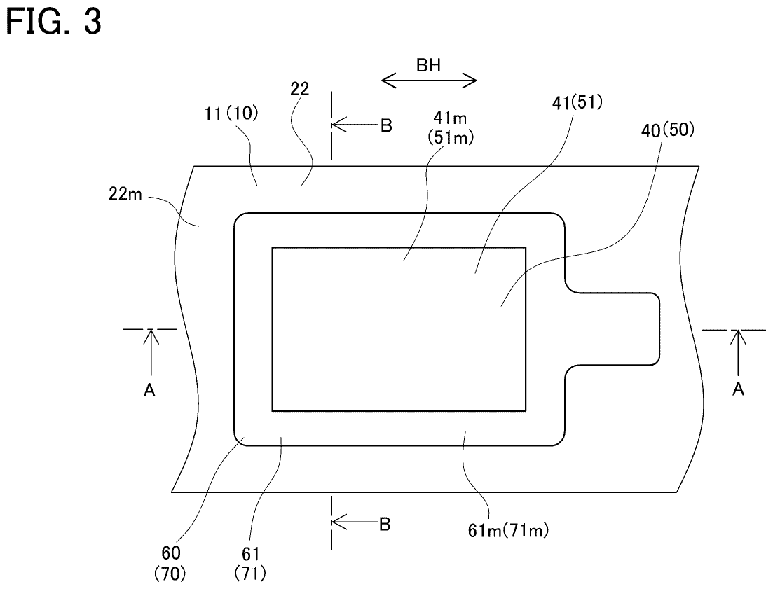

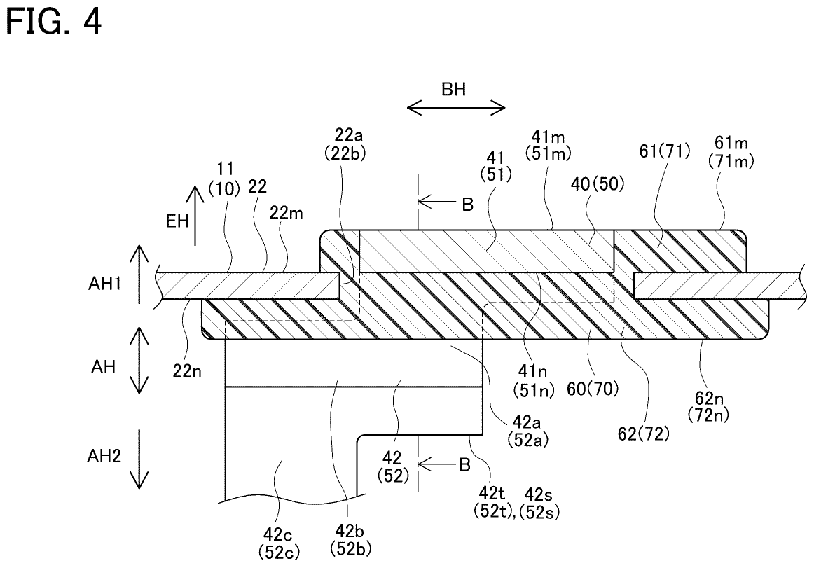

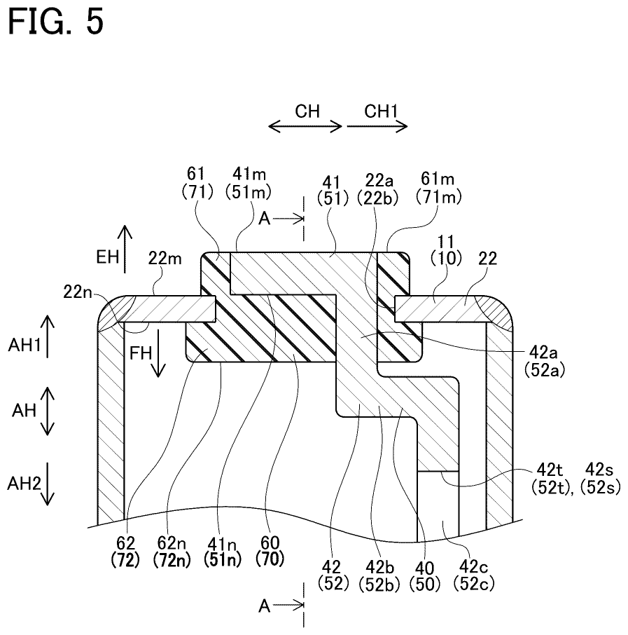

Hereinafter, an embodiment of the present disclosure will be described with reference to the accompanying drawings. FIG. 1 is a perspective view of a battery (one example of a power storage device of the present disclosure) 1 of the present embodiment, and FIG. 2 shows a cross-sectional view of the battery 1. Further, FIG. 3 shows a partially enlarged top view of a terminal member 40 and a resin member 60, and their surroundings. FIGS. 4 and 5 show partially enlarged sectional views of the terminal member 40 and the resin member 60, and their surroundings. It is to be noted that a terminal member 50 and a resin member 70 are respectively identical in configuration to the terminal member 40 and the resin member 60 and therefore the reference signs of the terminal member 50, the resin member 70, and their parts are noted together in parentheses. Hereinafter, for the following description, a battery height direction AH, a battery width direction BH, and a battery thickness direction CH of the battery 1 are defined as directions indicated in FIGS. 1 to 5. The battery 1 is a rectangular i.e., a rectangular parallelepiped box-like shape, sealed lithium-ion secondary battery which will be installed in vehicles such as a hybrid car, a plug-in hybrid car, and an electric automobile.

The battery 1 includes a case 10, a flat wound electrode body 30 housed in the case 10, a positive terminal member 40 and a negative terminal member 50 supported on a case upper portion 11 i.e., a lid 22 of the case 10, and others. The electrode body 30 is covered with a bag-shaped insulating holder 5 formed of an insulating film, opening on an upper side AH1 in the battery height direction AH in the case 10. The case 10 contains therein an electrolyte 3, a part of which is impregnated in the electrode body 30, and the remainder of which is accumulated on a case bottom portion 12 of the case 10.

The case 10 has a rectangular parallelepiped box-like shape made of metal (e.g., aluminum in the present embodiment) and includes the rectangular case upper portion 11 located on the upper side AH1 in the battery height direction AH, the rectangular case bottom portion 12 opposing the case upper portion 11 and located on a lower side AH2 in the battery height direction AH, and four rectangular case side portions 13, 14, 15, and 16 connecting the case upper portion 11 and the case bottom portion 12. The case 10 includes a bottomed rectangular tubular case body 21 including a rectangular annular opening portion 21c on the upper side AH1, and the rectangular plate-shaped lid (one example of a case member of the present disclosure) 22 which is laser-welded to the case body 21 over the entire circumference thereof to close the opening portion 21c.

A safety valve 28, which will break and open when the internal pressure of the case 10 exceeds a valve opening pressure, is provided in the case upper portion 11 (i.e., the lid 22). A liquid inlet 22k for communication between the inside and the outside of the case 10 is provided in the lid 22 and is hermetically sealed by a disc-shaped sealing member 29 made of aluminum.

The lid 22 is further provided with rectangular insertion holes 22a and 22b, which are located near an end on one side BH1 and near an end on the other side BH2 in the battery width direction BH, respectively. The positive terminal member 40 made of aluminum is inserted in the insertion hole 22a and fixed to the lid 22 in a state insulated from the case 10 by the resin member 60. In addition, the negative terminal member 50 made of copper is inserted in the other insertion hole 22b and fixed to the lid 22 in a state insulated from the case by the resin member 70.

These terminal members 40 and 50 are each formed by punching a metal plate (concretely, an aluminum plate for the positive terminal member 40 and a copper plate for the negative terminal member 50) into a predetermined shape and bending the metal plate. The terminal members 40 and 50 are respectively provided with terminal outer portions 41 and 51 positioned on an outer side EH of the lid 22 and terminal inner portions 42 and 52 mainly located inside the case 10 and respectively connected to the terminal outer portions 41 and 51 through the insertion holes 22a and 22b.

The terminal outer portions 41 and 51 of rectangular plate-like shapes include rectangular flat terminal top surfaces 41m and 51m, respectively. These terminal top surfaces 41m and 51m have no resin burrs, and thus the terminal top surfaces 41m and 51m are entirely exposed.

On the other hand, the terminal inner portions 42 and 52 are bent at plural points in a plate thick direction. Specifically, the terminal inner portions 42 and 52 are provided with first inner portions 42a and 52a extending from end portions of the terminal outer portions 41 and 51 on one side CHI in the battery thickness direction CH to the lower side AH2 in the terminal outer portions 41 and 51, second inner portions 42b and 52b being bent at lower ends of the first inner portions 42a and 52a and extending to the one side CHI in the battery thickness direction CH, and third inner portions 42c and 52c being bent at ends of the respective second inner portions 42b and 52b on the one side CHI in the battery thickness direction CH and extending to the lower side AH2.

Out of these inner portions, the first inner portions 42a and 52a are inserted in the insertion holes 22a and 22b and joined to the resin members 60 and 70, respectively.

The third inner portions 42c and 52c are connected to the electrode body 30 at their end portions on the lower side AH2. Specifically, the third inner portion 42c of the positive electrode is connected and conducted with a positive current collecting portion 33 of the electrode body 30 which will be explained below. On the other hand, the third inner portion 52c of a negative electrode is connected and conducted with a negative current collecting portion 36 of the electrode body 30 which will be explained below. Further, the third inner portions 42c and 52c are provided at portions located on the upper side AH1 continuing to the second inner portions 42b and 52b with to-be-contacted portions 42t and 52t to which a contact portion DE2a of a lower mold DE2 will be contacted from the lower side AH2 in an insert-molding step S1 explained below. In the present embodiment, these to-be-contacted portions 42t and 52t are also configured as deformed portions 42s and 52s that will be compressed and elastically deformed in the battery height direction AH (i.e., the orthogonal direction GH) in the insert-molding step S1.

Next, the resin members 60 and 70 are explained. The resin member 60 of the positive electrode insulates between the lid 22 and the terminal member 40 and is joined to the lid 22 and the terminal member 40 to fix the terminal member 40 to the lid 22. Further, the resin member 70 of the negative electrode insulates between the lid 22 and the terminal member 50 and is joined to the lid 22 and the terminal member 50 to fix the terminal member 50 to the lid 22.

These resin members 60 and 70 are made of polyphenylene sulfide (PPS). The resin members 60 and 70 include resin outer frame portions 61 and 71 positioned on the outer side EH of the lid 22 and resin inner portions 62 and 72 positioned inside the case 10 and the insertion holes 22a and 22b of the lid 22 and connected to the resin outer frame portions 61 and 71, respectively. The resin outer frame portions 61 and 71 are each of a frame shape surrounding a periphery of the respective terminal outer portions 41 and 51 of the terminal members 40 and 50, which are flush with each of terminal top surfaces 41m and 51m of the terminal outer portions 41 and 51. The resin outer frame portion 61 insulates between the terminal outer portion 41 of the terminal member 40 and the lid 22, while the resin outer frame portion 71 insulates between the terminal outer portion 51 of the terminal member 50 and the lid 22. On the other hand, the resin inner portion 62 insulates between the terminal inner portion 42 of the terminal member 40 and the lid 22, while the resin inner portion 72 insulates between the terminal inner portion 52 of the terminal member 50 and the lid 22.

Next, the electrode body 30 is explained. The electrode body 30 is formed of a strip-shaped positive electrode plate 31 and a strip-shaped negative electrode plate 34 which are stacked alternately with a pair of strip-shaped separators 37, each composed of a strip-shaped porous resin film, interposed one between the electrode plates 31 and 34, and this stacked assembly is wound into a cylindrical shape, and then pressed into a flat shape. The electrode body 30 is housed in the case 10 oriented sideways with its axis coinciding with the battery width direction BH. An end portion of the electrode body 30 on the one side BH1 in the battery width direction BH is a positive current collecting portion 33 in which a positive current collecting foil 32 of the positive electrode plate 31 protrudes in a spiral form. The positive current collecting portion 33 is joined to a third inner portion 42c of the terminal inner portion 42 of the positive terminal member 40. Further, another end portion of the electrode body 30 on the other side BH2 in the battery width direction BH is a negative current collecting portion 36 in which a negative current collecting foil 35 of the negative electrode plate 34 protrudes in a spiral form. The negative current collecting portion 36 is joined to a third inner portion 52c of the terminal inner portion 52 of the negative terminal member 50.

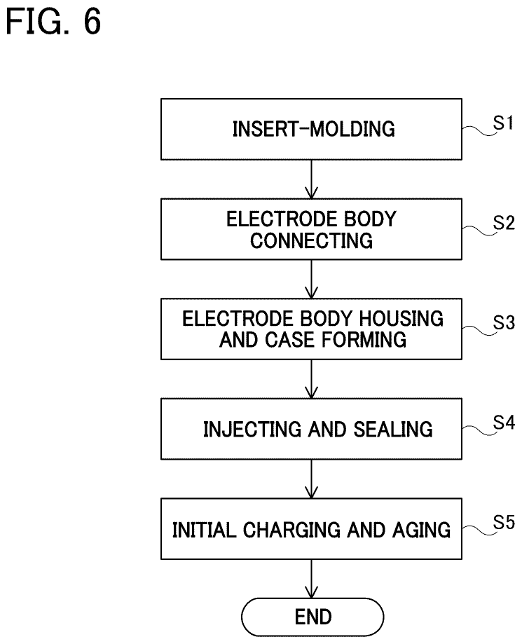

A method for producing the above-mentioned battery 1 is now explained (see FIGS. 6 to 8). The lid 22 and the terminal members 40 and 50 are prepared in advance. The lid 22 is formed by punching an aluminum plate into a predetermined shape with a liquid inlet 22k, the insertion holes 22a and 22b, and the safety valve 28. The positive terminal member is formed by punching the aluminum plate into a predetermined shape and bending the aluminum plate, and similarly the negative terminal member 50 is formed by punching a copper plate into a predetermined shape and bending the copper plate.

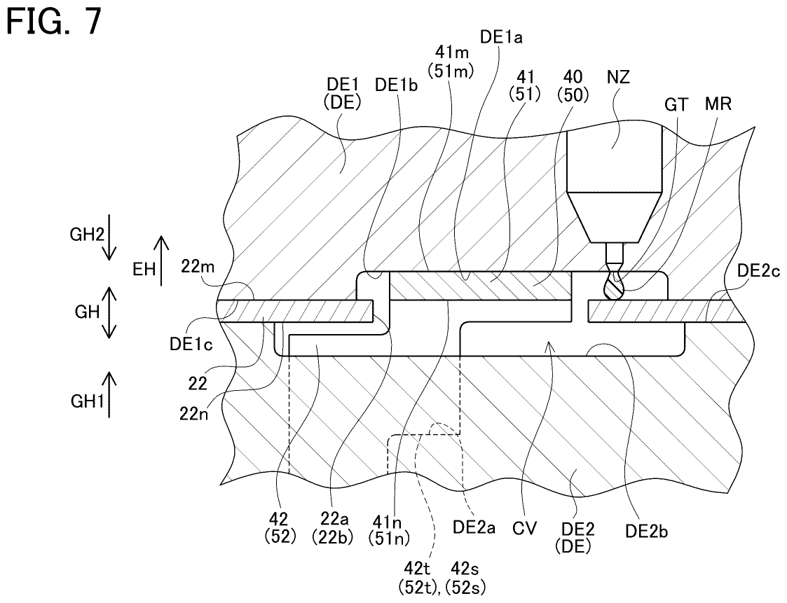

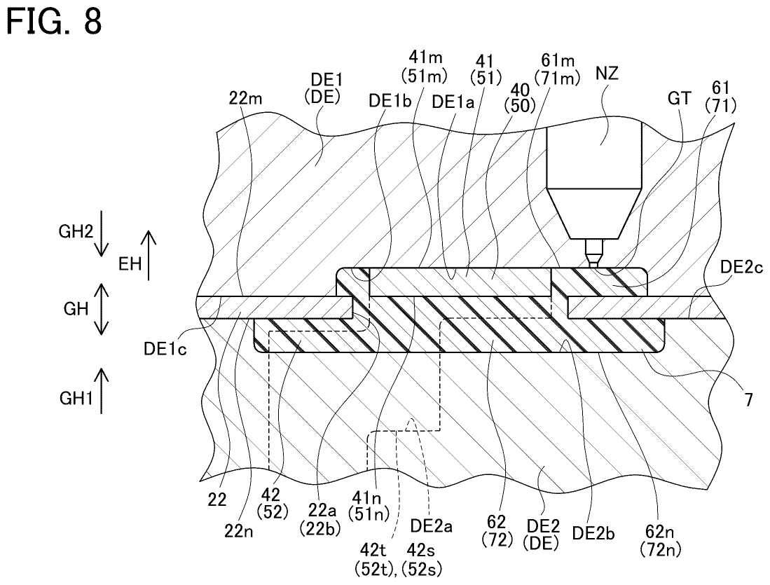

Then, in an insert-molding step S1 (see FIG. 6), the terminal members 40 and 50 are inserted in the insertion holes 22a and 22b of the lid 22, respectively, and then the resin members 60 and 70 are made by insert-molding to form a lid assembly 7 (see FIGS. 7 and 8). This insert-molding step S1 is performed by use of a molding mold DE including an upper mold (a first mold) DE1 and a lower mold (a second mold) DE2 (see FIG. 7).

A pair of injection nozzles NZ are placed in the upper mold DE1 and allowed to inject molten resin MR from a gate GT formed in the tip end into each of cavities CV provided in a pair, one of which is defined by the lid 22, the terminal member 40, and the molding mold DE and the other of which is defined by the lid 22, the terminal member 50, and the molding mold DE.

The upper mold DE1 includes a pair of flat top-face close-contact portions DE1a which is to face and tightly contact with the terminal top surfaces 41m and 51m of the terminal outer portions 41 and 51 of the terminal members 40 and 50, a pair of outer-surface forming portions DE1b forming the outer surfaces 61m and 71m of the resin outer-frame portions 61 and 71 of the resin members 60 and 70, and a flat lid close-contact portion DE1c extending to a radial outside to surround the respective outer-surface forming portions DE1b and oppose and tightly contact with the lid outer surface 22m of the lid 22.

The lower mold DE2 includes a pair of inner surface forming portions DE2b for forming inner surfaces 62n and 72n of the resin inner portions 62 and 72 of the resin members 60 and 70 and a flat lid close-contact portion DE2c surrounding each inner surface forming portions DE2b and extending radially outward, which is to face and contact with the lid inner surface 22n of the lid 22. Further, the lower mold DE2 includes a pair of contact portions DE2a to be in contact with to-be-contacted portions 42t and 52t of the terminal inner portions 42 and 52 of the terminal members 40 and 50.

In the insert-molding step S1, the lid 22 is firstly placed on a predetermined position in the lower mold DE2. Subsequently, the terminal members 40 and 50 are respectively inserted into the insertion holes 22a and 22b of the lid 22 placed in the lower mold DE2. Thereafter, the upper mold DE 1 and the lower mold DE2 are moved relatively in the orthogonal direction GH orthogonal to the top-face close-contact portion DE1a, and in the present embodiment, the position of the lower mold DE2 is fixed and the upper mold DE1 is moved toward a lower-mold side GH2, i.e., a second-mold side as a lower side in the orthogonal direction GH.

Then, the top-face close-contact portion DE1a of the upper mold DE1 presses the terminal top surfaces 41m and 51m of the terminal outer portions 41 and 51 of the terminal members 40 and 50 to the lower-mold side GH2 in the orthogonal direction GH, and the contact portions DE2a of the lower mold DE2 press the to-be-contacted portions 42t and 52t of the terminal inner portions 42 and 52 of the terminal members 40 and 50 to the upper-mold side GH1 in the orthogonal direction GH. Further, in the terminal members 40 and 50, a deformed portion 42s positioned between the terminal top surface 41m and the to-be-contacted portion 42t and a deformed portion 52s positioned between the terminal top surface 51m and the to-be-contacted portion 52t (in the present embodiment, the deformed portions 42s and 52s constitute the to-be-contacted portions 42t and 52t) are compressed to be elastically deformed in the orthogonal direction GH so that the terminal top surfaces 41m and 51m are pressed to be in close contact with the top-face close-contact portion DE1a. Further, the lid close-contact portion DE1c of the upper mold DE1 is made to face and brought into close contact with the lid outer surface 22m of the lid 22, and the lid close-contact portion DE2c of the lower mold DE2 is made to face and brought into close contact with the lid inner surface 22n of the lid 22.

In the present embodiment, the deformed portions 42s and 52s of the terminal members 40 and 50 are compressed and elastically deformed in the orthogonal direction GH, and thus the terminal top surfaces 41m and 51m can be brought into close contact with the top-face close-contact portion DE1a by the force of almost the same magnitude with no influence of variation in dimensions of the respective terminal members 40 and 50 in the orthogonal direction GH.

In the above state, the molten resin MR is injected from the respective gates GT into the cavities CV to spread over the entire cavities CV. At this time, the terminal top surfaces 41m and 51m of the terminal members 40 and 50 are in close contact with the top-face close-contact portion DE1a of the upper mold DE1 by the reaction force generated in the deformed portions 42s and 52s of the terminal members 40 and 50, and thus the molten resin MR is less likely to flow in between the terminal top surfaces 41m and 51m and the top-face close-contact portions DE1a.

Thereafter, the molten resin MR filled in the respective entire cavities CV is cooled down to form the resin members 60 and 70 in the cavities CV. Then, the upper mold DE1 is moved upward to take out the lid assembly 7, in which the terminal members 40 and 50 are fixed to the lid 22 via the resin members 60 and 70, from the lower mold DE2. In the present embodiment, as mentioned above, the to-be-contacted portions 42t and 52t of the terminal members 40 and 50, to which the contact portion DE2a of the lower mold DE2 is contacted, are formed as the deformed portions 42s and 52s which will be elastically deformed. The to-be-contacted portions 42t and 52t (i.e., the deformed portions 42s and 52s) of the terminal members 40 and 50 protrude and are exposed from the resin members 60 and 70. Accordingly, a state of elastic deformation generated in the to-be-contacted portions 42t and 52t (i.e., the deformed portions 42s and 52s) can be easily confirmed by visually checking the lid assembly 7 that has been taken out of the lower mold DE2.

Next, in an electrode body connecting step S2 (see FIG. 6), the strip-shaped positive electrode plate 31, the strip-shaped negative electrode plate 34, and the pair of strip-shaped separators 37 are wound and pressed into a flat shape to prepare the electrode body 30. The positive current collecting portion 33 and the negative current collecting portion 36 of the thus prepared electrode body 30 are each ultrasonically welded with the respective terminal inner portions 42 and 52 of the terminal members 40 and 50 of the above-mentioned lid assembly 7 (see FIG. 1 and FIG. 2). Thereafter, the electrode body 30 is wrapped by the bag-shaped insulating holder 5.

Subsequently, in an electrode body housing and case forming step S3, the case body 21 is prepared and the electrode body 30 covered with the above-mentioned insulating holder 5 is inserted in the case body 21, and then, the opening portion 21c of the case body 21 is closed by the lid 22. The opening portion 21c of the case body 21 and a peripheral edge portion of the lid 22 are laser-welded over the entire circumference to form the case 10 in which the electrode body 30 is housed.

Subsequently, in an injection and sealing step S4, the electrolyte 3 is injected in the case 10 through the liquid inlet 22k so that the electrolyte 3 is impregnated in the electrode body 30. Thereafter, the liquid inlet 22k is covered from outside by the sealing member 29, and the sealing member 29 is laser-welded to the lid 22 so that the sealing member 29 and the lid 22 are hermetically closed.

Subsequently, in an initial charging and aging step S5, the battery 1 is connected to a charging device (not shown) to initially charging the battery 1. Thereafter, the initially charged battery 1 is left stand for a predetermined time for aging the battery 1. Thus, the battery 1 is completed.

As explained above, in the method for producing the battery 1, the upper mold DE 1 and the lower mold DE2 are relatively moved in the orthogonal direction GH to compress and elastically deform the deformed portions 42s and 52s of the terminal members 40 and 50 in the orthogonal direction GH in the insert-molding step S1. Accordingly, the terminal top surfaces 41m and 51m of the terminal members 40 and 50 can be pressed to be in close contact with the top-face close-contact portion DE1a of the upper mold DE1 with the force of the almost same magnitude with no influence of variation in the dimensions of the respective terminal members 40 and 50. The resin members 60 and 70 are then insert-molded in this state. Thus, during formation of the resin members 60 and 70, the terminal top surfaces 41m and 51m of the terminal members 40 and 50 are brought into close contact with the top-face close-contact portion DE1a of the upper mold DE1 by the reaction force generated in the deformed portions 42s and 52s of the terminal members 40 and 50, so that the molten resin MR is less likely to flow in between each of the terminal top surfaces 41m and 51m and the top-face close-contact portion DE1a. Therefore, irrespective of variation in the dimensions of the respective terminal members 40 and 50, generation of resin burrs on the terminal top surfaces 41m and 51m can be prevented.

Further in the present embodiment, the to-be-contacted portions 42t and 52t of the terminal members 40 and 50 to be in contact with the contact portion DE2a of the lower mold DE2 constitute the deformed portions 42s and 52s which are to be elastically deformed. The to-be-contacted portions 42t and 52t are exposed from the resin members 60 and 70, and thus a state of elastic deformation generated in the to-be-contacted portions 42t and 52t (i.e., the deformed portions 42s and 52s) can be visually checked after the insert-molding step S1 by forming the to-be-contacted portions 42t and 52t as the deformed portions 42s and 52s.

The present disclosure has been explained with the embodiment as above, but the present disclosure is not limited to the embodiment and may be applied with any appropriate modifications without departing from the scope of the disclosure.

### REFERENCE SIGNS LIST

1 Battery (power storage device)
10 Case
21 Case body
22 Lid (case member)
22a,22b Insertion hole
30 Electrode body
40,50 Terminal member
41,51 Terminal outer portion
41m,51m Terminal top surface
42,52 Terminal inner portion
42a,52a First inner portion
42b,52b Second inner portion
42c,52c Third inner portion
42t,52t To-be-contacted portion (of the terminal inner portion)
42s,52s Deformed portion (of the terminal inner portion)
60,70 Resin member
61,71 Resin outer frame portion
EH Outer side (of the lid)
FH Inner side (of the lid)
GH Orthogonal direction
GH1 Upper-mold side (first-mold side in the orthogonal direction)
GH2 Lower-mold side (second-mold side in the orthogonal direction)
DE Molding mold
DE1 Upper mold (first mold)
DE1a Top-face close-contact portion
DE1b Outer-surface forming portion
DE1c Lid close-contact portion
DB2 Lower mold (second mold)
DE2a Contact portion
DE2b Inner-surface forming portion
DE2c Lid close-contact portion
MR Molten resin

What is claimed is:

1. A method for producing a power storage device,
the power storage device including:
a case member including an insertion hole;
a terminal member inserted in the insertion hole of the case member; and
a resin member configured to be joined to the case member and the terminal member, while insulating between the case member and the terminal member, to fix the terminal member to the case member,
the terminal member including:
a terminal outer portion located on an outer side of the case member and provided with a terminal top surface having an exposed flat shape; and
a terminal inner portion located on an inner side of the case member and connected to the terminal outer portion through the insertion hole,
the resin member including a resin outer frame portion located on the outer side of the case member in a frame shape to surround a periphery of the terminal outer portion of the terminal member, the resin outer frame portion being flush with the terminal top surface of the terminal outer portion, wherein
the method comprises insert-molding the resin member while the terminal member is inserted in the insertion hole of the case member,
insert-molding includes:
relatively moving a first mold having a flat top-face contact portion configured to face and tightly contact with the terminal top surface of the terminal outer portion and a second mold having a contact portion to contact with a to-be-contacted portion of the terminal inner portion in an orthogonal direction orthogonal to the top-face contact portion;
pressing the terminal top surface by the top-face contact portion of the first mold to a second-mold side in the orthogonal direction and pressing the to-be-contacted portion by the contact portion of the second mold to a first-mold side in the orthogonal direction; and
insert-molding the resin member in a state in which a deformed portion of the terminal member positioned between the terminal top surface and the to-be-contacted portion is compressed and elastically deformed in the orthogonal direction to press and tightly contact with the terminal top surface on the top-face contact portion.

2. The method for producing the power storage device according to claim 1, wherein the deformed portion of the terminal member is the to-be-contacted portion.
